(19) United States
(12) Patent Application Publication
(10) Pub. No.: US 2025/0002380 A1
(43) Pub. Date: Jan. 2, 2025

(54) PLASMA FUNCTIONAL LIQUID PRODUCING DEVICE, A METHOD THEREOF, AND PLANT CULTIVATING FACTORY

(71) Applicants: LAUREL BANK MACHINES CO., LTD., Tokyo (JP); TOKYO INSTITUTE OF TECHNOLOGY, Tokyo (JP); AOBA GAKUEN EDUCATIONAL CORPORATION, Tokyo (JP); NATIONAL UNIVERSITY CORPORATION KOBE UNIVERSITY, Kobe-shi (JP)

(72) Inventors: Yoshikazu YAMAGATA, Tokyo (JP); Hideyuki NAKANISHI, Tokyo (JP); Shigeki OZAWA, Tokyo (JP); Akitoshi OKINO, Tokyo (JP); Yuma SUENAGA, Tokyo (JP); Zhizhi LIU, Tokyo (JP); Taiki OSAWA, Tokyo (JP); Atsuo IWASAWA, Tokyo (JP); Yuriko AMANO, Tokyo (JP); Yuichi UNO, Kobe-shi (JP)

(21) Appl. No.: 18/882,624

(22) Filed: Sep. 11, 2024

Related U.S. Application Data
(63) Continuation of application No. PCT/JP2023/004619, filed on Feb. 10, 2023.

(30) Foreign Application Priority Data
Mar. 15, 2022 (JP) 2022-040834
Mar. 15, 2022 (JP) 2022-040835
Mar. 15, 2022 (JP) 2022-040836
Dec. 1, 2022 (JP) 2022-192657

(51) Int. Cl. C02F 1/50; A01G 9/24; A01G 31/02; B01F 23/231; B01F 23/2375; B01F 25/21; B01F 101/00; B01F 101/32; H05H 1/24

(52) U.S. Cl. CPC C02F 1/50; A01G 31/02; B01F 23/231265; B01F 23/2375; B01F 25/21; H05H 1/24; A01G 2009/248; B01F 2101/305; B01F 2101/32; C02F 2303/04; H05H 2245/20

(57) ABSTRACT

A Plasma functional liquid producing device, a method thereof, and a plant factory that exhibit excellent cleaning and sterilizing effects even when plasma gas is introduced into a liquid through bubbling. The Plasma functional liquid producing device comprises a plasma head that generates plasma gas containing active species from plasma generating gas, a plasma gas releasing section that releases the plasma gas in a bubbled state, and a Plasma functional liquid generating section equipped with a plasma functional liquid generating tank storing a solvent, which generates a plasma functional liquid by introducing the plasma gas in the bubbled state into the solvent, wherein the oxygen concentration of the plasma generating gas is preferably 90% or more.

### RELATED APPLICATION

This application is a continuation of International Patent Application PCT/JP2023/004619 with an international filing date of Feb. 10, 2023, which is herein incorporated by reference.

### FIELD OF THE INVENTION

The present invention relates to a Plasma functional liquid producing device, a method thereof, and a plant cultivating factory.

### BACKGROUND ART

Nowadays, studies of various technologies related to cleaning and sterilization (disinfection) using plasma are being made. Particularly, it is being examined to introduce plasma-processed gas (plasma gas) into a liquid (solvent) and to use active species such as ozone, ions or radicals generated by the plasma treatment to clean or sterilize the liquid.

Patent Literature 1 discloses introduction of ozone or radicals or the like generated through plasma into a liquid to be treated by bubbling to decompose organic substances or the like present in the liquid.

### CITATION LIST

### Patent Literature

Patent Literature 1: Japanese Patent Application Laid-Open No. 2008-178870

### SUMMARY OF THE INVENTION

### Problem the Invention is to Solve

In this connection, known methods of bubbling plasma gas are the venturi method in which a flow channel of liquid is temporarily narrowed to generated minute bubbles using pressure changes, or the microporous method in which gas is dispersed into a liquid flow from minute bubbles and in which bubbles generated by the micropores are separated through shear force of the liquid flow.

However, there were problems that ozone and radicals or the like generated through plasma tend to lose their activity due to pressure changes or shear heat and that no sufficient cleaning and sterilizing effects could be obtained depending on types of plasma gas.

This has given rise to a technical problem to be solved in order to achieve favorable cleaning and sterilizing effects also when plasma gas is introduced into a liquid through bubbling, and the present invention aims to solve this subject.

### Means for Solving the Problem

Upon performing keen research in view of the above-described situation, the inventors of the present invention have found that favorable cleaning and sterilizing effects can be obtained by introducing plasma gas derived from oxygen gas of a predetermined concentration into a solvent through bubbling, which lead to the completion of the present invention.

For achieving the above subject, a Plasma functional liquid producing device of the present invention has been configured to comprise a plasma gas generating section that generates plasma gas containing active species from plasma generating gas, a plasma gas releasing section that releases the plasma gas in a bubbled state, and a Plasma functional liquid generating section equipped with a plasma functional liquid generating tank storing a solvent, which generates a plasma functional liquid by introducing the plasma gas in the bubbled state into the solvent, wherein the oxygen concentration of the plasma generating gas is 90% or more.

Further, a plasma functional liquid generating method of the present invention has been configured to be a plasma functional liquid generating method that uses the Plasma functional liquid producing device comprising a plasma gas generating section that generates plasma gas containing active species from plasma generating gas, a plasma gas releasing section that releases the plasma gas in a bubbled state, and a Plasma functional liquid generating section equipped with a plasma functional liquid generating tank storing a solvent, which generates a plasma functional liquid by introducing the plasma gas in the bubbled state into the solvent, wherein the oxygen concentration of the plasma generating gas is 90% or more.

### Effects of the Invention

In the present invention, plasma gas that holds active species with excellent cleaning and sterilizing effects is generated from plasma generating gas with an oxygen concentration of 90% or more, and by introducing the plasma gas into the solvent in the plasma functional liquid generating tank in a bubbled stated upon passing through the plasma gas releasing section without accompanying excessive heat generation or pressure fluctuations, it is possible to obtain a plasma functional liquid containing long-life active species, which exhibits excellent cleaning and sterilizing effects.

### BRIEF DESCRIPTION OF THE DRAWINGS

FIG. 1 is a schematic view showing a configuration of a Plasma functional liquid producing device according to a first embodiment of the present invention.

FIG. 2 is a schematic view showing a configuration of a plant cultivating factory according to a second embodiment of the present invention.

FIG. 3 is a schematic view showing a configuration of a plant cultivating factory according to a first variation of the second embodiment.

FIG. 4 is a schematic view showing a configuration of a plant cultivating factory according to a second variation of the second embodiment.

FIG. 5 is a schematic view showing a configuration of a plant cultivating factory according to a third variation of the second embodiment.

FIGS. 6A-B is a schematic view showing a configuration of a plant cultivating factory according to a fourth variation of the second embodiment.

FIG. 7 is a schematic view showing a configuration of a Plasma functional liquid producing device according to a third embodiment of the present invention.

FIG. 8 is a longitudinal sectional view showing main parts of a plasma head shown in FIG. 7.

FIG. 9 is a schematic view showing a configuration of a Plasma functional liquid producing device according to a fourth embodiment of the present invention.

FIG. 10 is a longitudinal sectional view showing main parts of a plasma head shown in FIG. 9.

FIG. 11 is a schematic view showing experimental procedures of an experimental example.

FIG. 12 is a graph showing experimental results of a first experimental example.

FIG. 13 is a schematic view showing experimental procedures of a second experimental example.

FIG. 14 is a graph showing experimental results of the second experimental example.

FIG. 15 is a graph showing experimental results of a third experimental example.

FIG. 16 is a graph showing experimental results of a fourth experimental example.

FIG. 17 is a graph showing experimental results of a fifth experimental example.

### DETAILED DESCRIPTION OF THE PREFERRED EMBODIMENTS

Various embodiments of the present invention will respectively be described based on the drawings. Note that in the following, when reference is made to numbers, numeric values, quantities, or ranges of components or the like, it does not mean that the specific numbers are limitative unless specifically indicated otherwise and unless the specific numbers are clearly limitative by principle, and numbers could be more or less than the specific numbers.

Further, when reference is made to shapes or positional relationships of components, those substantially similarly to or approximating the shapes or the like are to be included unless specifically indicated otherwise and unless it can be clearly considered by principle that they do or are not.

Further, drawings might be exaggerated by enlarging characteristic parts or the like for ease of understanding features, and dimensional proportions or the like of components might not be identical to actual ones. Further, in cross-sectional views, hatchings of some components might be omitted for ease of understanding sectional configurations of components.

### First Embodiment

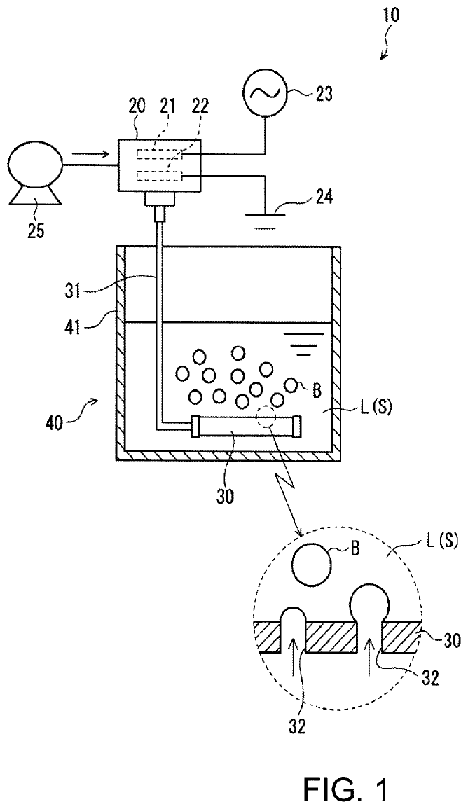

First, a Plasma functional liquid producing device 10 according to a first embodiment of the present invention will be described based on the drawing. FIG. 1 is a schematic view showing a configuration of the Plasma functional liquid producing device 10. The Plasma functional liquid producing device 10 generates a plasma functional liquid L with excellent cleaning and sterilizing effects.

The Plasma functional liquid producing device 10 comprises a plasma head 20, which is a plasma gas generating section. The plasma head 20 can be of any configuration as long as it generates plasma, while it is preferable to use an atmospheric plasma device that generates plasma at near atmospheric pressure. An atmospheric plasma device is smaller, easier to operate and safer compared to a low-pressure plasma device such as a vacuum plasma device or the like. Moreover, an atmospheric plasma device is capable of generating active species of high concentrations compared to a low-pressure plasma device.

In the interior of the plasma head 20, there are provided a plate-like first electrode 21 and a second electrode 22, which are arranged to face each other with a space between them. High-frequency voltage is applied to the first electrode 21 by a power source 23. The second electrode 22 is connected to a ground 24.

Plasma generating gas is sent to the space between the first electrode 21 and the second electrode 22 via a compressor 25. The plasma generating gas is a gas that causes generation of plasma and contains at least oxygen gas. It is preferable that the oxygen concentration of the plasma generating gas is 90% or more, preferably 90% or more and 95% or less with which excellent cleaning and sterilizing effects can be achieved. When necessary, it is possible to preliminarily adjust the oxygen concentration of the plasma generating gas by means of an oxygen concentrator (not shown). Note that when the oxygen concentration of the plasma generating gas is less than 100%, the plasma generating gas contains nitrogen components or the like. Particularly, when a plasma generating gas with an oxygen concentration of 95% is generated with a PSA-type oxygen concentrator that generates high-concentration oxygen by making zeolite absorb nitrogen from the air, approximately 0.5% nitrogen will be theoretically contained. It is preferable that the nitrogen components of the plasma generating gas is 5% or less.

The plasma head 20 is connected to a plasma gas releasing section 30 via a gas conveying channel 31. The separation of the plasma head 20 and the plasma gas releasing section 30 restricts transfer of heat generated in the plasma head 20 to the plasma gas releasing section 30.

One end of the gas conveying channel 31 is connected to the plasma head 20 while the other end is connected to the plasma gas releasing section 30 to send plasma gas generated in the plasma head 20 to the plasma gas releasing section 30. Note that pressure is applied to plasma gas to a degree that restricts backflow from the plasma gas releasing section 30 to the plasma head 20.

The plasma gas releasing section 30 is immersed in a liquid in a plasma functional liquid generating tank 41 to be described later. The plasma gas releasing section 30 has, for instance, a hollow, substantially cylindrical shape and is a porous member formed with a number of pores 32 on the outer peripheral surface thereof. The plasma gas releasing section 30 introduces bubbles B of plasma gas into a solvent S in the plasma functional liquid generating tank 41 by making the plasma gas supplied to its interior to pass through the pores 32.

The pore diameter of the pores 32 can be arbitrarily set depending on the bubble diameter of the bubbles B to be introduced into the solvent S in the plasma functional liquid generating tank 41. For instance, it is possible to generate microbubbles with a bubble diameter of approximately 1 mm to 100 mm and ultrafine bubbles with a bubble diameter of approximately tens of nm to 1 mm depending on the pore diameter of the pores 32.

The bubbles B contain active species such as ozone, hydrogen peroxide, hydroxyl radicals, nitrogen oxides, and singlet oxygen, depending on the type of plasma generating gas. In the description, “active species” are radicals or the like that are generated by activating plasma generating gas by plasma. Radicals that are contained in plasma gas differ depending on the type of plasma generating gas for generating plasma gas. For example, oxygen radicals are generated when the plasma generating gas contains oxygen components, and nitrogen oxide radicals are generated when the plasma generating gas contains nitrogen components. Further, nitrate nitrogen (nitrate radicals) is useful for the growth of plants.

The plasma gas releasing section 30 is made, for example, of metal, ceramics, or plastic, preferably copper, silver, or an alloy thereof. This allows introduction of copper or silver ion into the solvent S.

The Plasma functional liquid producing device 10 comprises a Plasma functional liquid generating section 40 that generates a plasma functional liquid L. In the description, the “plasma functional liquid L” is a solution in in which active species held in plasma gas have gradually dissolved in the solvent S after being held by the bubbles B in the solvent S. In other words, the plasma functional liquid L contains active species held by the bubbles B or active species dissolved in the solvent S. Dissolution of active species in the solvent S cleans and sterilizes the solvent S itself, and the plasma functional liquid L cleans and sterilizes other objects.

The Plasma functional liquid generating section 40 comprises the plasma functional liquid generating tank 41 that stores the solvent S and immerses the plasma gas releasing section 30 in the solvent S. The plasma functional liquid generating tank 41 is not provided with stirring blades or the like for stirring the solvent S, and generation of air flow is restricted in the solvent S. The solvent S includes, but is not limited to, water such as pure water, ion exchanged water, purified water or distilled water, a solution that contains mineral nutrients, or a liquid fertilizer or the like. Note that when a liquid fertilizer is used as the solvent S, the plasma functional liquid L can disinfect fungi that are contained in the liquid fertilizer and make the liquid fertilizers contain active species that are suitable for the growth of plants.

It is preferable that the bubbles B are microbubbles or ultrafine bubbles that are being held in the solvent S for a long time. Particularly, when the bubbles S are ultrafine bubbles, it is possible to maintain the bubbled state for a long time since little buoyance acts on the bubbles B.

In this way, the Plasma functional liquid producing device 10 has been configured to comprise the plasma head 20 that generates plasma gas containing active species from plasma generating gas, the plasma gas releasing section 30 that releases the plasma gas in a bubbled state, and the Plasma functional liquid generating section 40 equipped with the plasma functional liquid generating tank 41 storing a solvent S, which generates a plasma functional liquid L by introducing the plasma gas in a bubbled state into the solvent S, wherein the oxygen concentration of the plasma generating gas is 90% or more.

With this configuration, a plasma gas holding active species with excellent cleaning and sterilizing effects is generated from a plasma generating gas with an oxygen concentration of 90% or more, and by introducing this plasma gas into the solvent S in the plasma functional liquid generating tank 41 in a bubbled state upon passing through the pores 32 of the plasma gas releasing section 30 without accompanying heat generation or pressure fluctuations, it is possible to obtain a plasma functional liquid L that contains long-life active species that exhibits excellent cleaning and sterilizing effects.

The Plasma functional liquid producing device 10 according to the present embodiment has been configured that the oxygen concentration of the plasma generating gas is 90% or more and 95% or less.

With this configuration, it is possible to easily obtain a plasma generating gas by using a small-sized oxygen concentrator, and to obtain a plasma functional liquid L with excellent workability and economy since generation of ozone, which is generated when the oxygen concentration is excessively high, is restricted.

The Plasma functional liquid producing device 10 according to the present embodiment has been configured that the nitrogen concentration of the plasma generating gas is 0.5% or more.

With this configuration, it is possible to obtain a plasma functional liquid L suitable for the growth of plants since nitrate ion derived from nitrogen gas that is contained in the plasma generating gas is dissolved in the plasma functional liquid L.

The Plasma functional liquid producing device 10 according to the present embodiment has been configured that the plasma head 20 is arranged outside the plasma functional liquid generating tank 41, and that the plasma gas releasing section 30 is a porous member that is immersed in the solvent S stored in the plasma functional liquid generating tank 41 and that releases the plasma gas in a bubbled state when the plasma gas passes through.

With this configuration, since the plasma head 20 is arranged outside the plasma functional liquid generating tank 41 and plasma gas is introduced into the solvent S from the plasma gas releasing section 30 that is immersed in the solvent S, it is possible to restrict loss of activity of the active species that are contained in the plasma functional liquid L due to heat generated by the generation of plasma gas, and to prolong the lifetime of the active species.

The Plasma functional liquid producing device 10 according to the present embodiment has been configured that the plasma gas releasing section 30 is made of copper, silver, or an alloy thereof.

With this configuration, copper or silver ion eluted from the plasma gas releasing section 30 is introduced into the solvent S, which enables improvements in the cleaning and sterilizing effects of the plasma functional liquid L.

The Plasma functional liquid producing device 10 according to the present embodiment has been configured that the bubbles of the plasma gas are microbubbles or ultrafine bubbles.

With this configuration, bubbles B are held over a long period of time so that the active species that are contained in the plasma functional liquid L are maintained for a long period of time.

### Second Embodiment

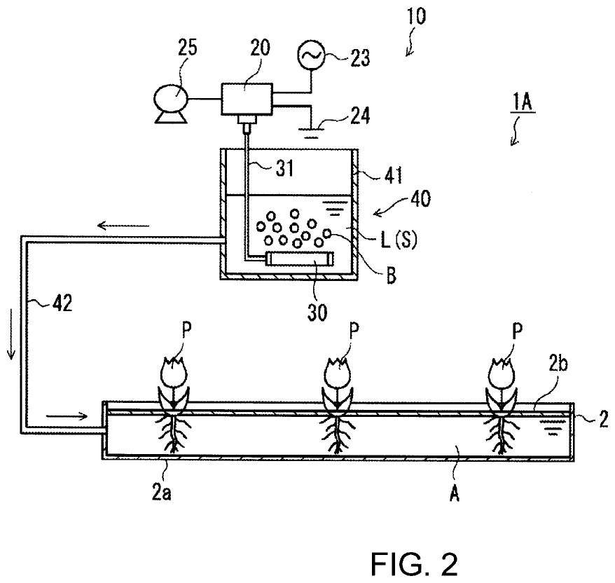

Next, a plant factory 1A according to a second embodiment of the present invention will be described based on the drawing. FIG. 2 is a schematic view showing a configuration of the plant factory 1A according to the second embodiment. The plant factory 1A comprises a cultivating tank 2 for hydroponically growing plants P and a Plasma functional liquid producing device 10.

The cultivating tank 2 comprises a container 2a that stores a solution A containing a liquid fertilizer, and a supporting section 2b that supports the plants P such that underground parts of the plants P reach the solution A in the container 2a.

The Plasma functional liquid generating section 40 comprises a liquid supplying channel 42 as a releasing section for sending the plasma functional liquid L to the container 2a. An upstream end of the liquid supplying channel 42 is connected to the plasma functional liquid tank 41 while a downstream end thereof is connected to the container 2a. The plasma functional liquid L that is sent by the liquid supplying channel 42 is pressure fed by means of a pump or the like (not shown) and mixed to the solution A. Note that the solution A does not necessarily have to contain a liquid fertilizer.

In this way, the plasma functional liquid L generated in the Plasma functional liquid producing device 10 is sent to the cultivating tank 2 via the liquid supplying channel 42, and the solution A in the cultivating tank 2 is sterilized or disinfected by the plasma functional liquid L to enable favorable growth of the plants P.

### <First Variation>

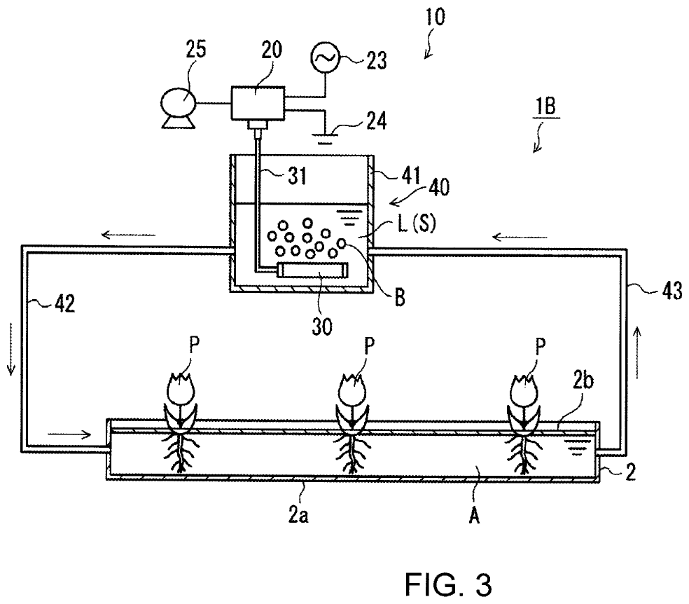

Next, a variation of the plant factory 1A according to the second embodiment will be described based on the drawing. FIG. 3 is a schematic view showing a configuration of a plant factory 1B according to the present variation. Note that the plant factory 1B according to the present variation differs from the plant factory 1A according to the above-described second embodiment in the following points while other configurations are identical. Therefore, identical configurations will be marked with identical reference marks and repetitive descriptions will be omitted.

Both of the solution A in the container 2a and the solvent S in the plasma functional liquid generating tank 41 include a liquid fertilizer. Further, the plasma generating gas contains nitrogen components, and the plasma functional liquid contains nitrate nitrogen (nitrate radicals) that is a nutrient for plants.

The Plasma functional liquid generating section 40 comprises a liquid refluxing channel 43 that connects the container 2a and the plasma functional liquid generating tank 41. An upstream end of the liquid refluxing channel 43 is connected to the container 2a while a downstream end thereof is connected to the plasma functional liquid generating tank 41. The solution and the plasma functional liquid L in the container 2a are refluxed from the container 2a to the plasma functional liquid generating tank 41 via the liquid refluxing channel 43 by means of a pump or the like (not shown). In other words, the solution A is made to reflux through the container 2a and the plasma functional liquid generating tank 41 via the liquid supplying channel 42 and the liquid refluxing channel 43.

The solution that has been refluxed from the container 2a is mixed into the solvent S that is stored in the plasma functional liquid generating tank 41, and bubbles B of plasma gas released from the plasma gas releasing section 30 are introduced into the solvent S stored in the plasma functional liquid generating tank 41. In this way, the plasma functional liquid L with active species being dissolved therein refluxes between the Plasma functional liquid generating section 40 and the cultivating tank 2.

Further, since the lifetime of the liquid fertilizers that are contained in the solvent S and the solution A as fertilizers is longer than the lifetime of the active species, the liquid fertilizers can be repeatedly used by continuing the supply of active species as described above.

### <Second Variation>

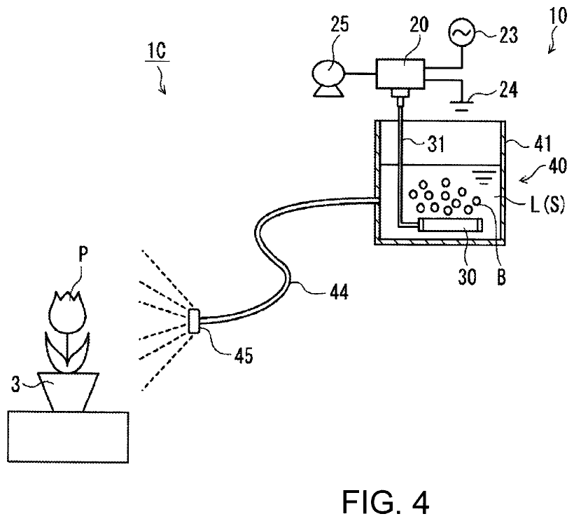

Next, another variation of the plant factory 1A according to the second embodiment will be described based on the drawing. FIG. 4 is a schematic view showing a configuration of a plant factory 1C according to the present variation. Note that the plant factory 1C according to the present variation differs from the plant factory 1A according to the above-described second embodiment in the following points while other configurations are identical. Therefore, identical configurations will be marked with identical reference marks and repetitive descriptions will be omitted.

The plant factory 1C comprises a cultivating container 3 for cultivating plants P planted into culture soil or the like and a Plasma functional liquid producing device 10.

A Plasma functional liquid generating section 40 comprises a liquid supplying pipe 44 and a spraying head 45 as the releasing section. A base end of the liquid supplying pipe 44 is connected to the plasma functional liquid generating tank 41 while a tip end thereof is connected to the spraying head 45. The plasma functional liquid L sent via the liquid supplying pipe 44 is pressure fed by means of a pump or the like (not shown). The liquid supplying pipe 44 is preferably flexible.

The spraying head 45 sprays the plasma functional liquid L to the outside. Flowers, leaves, stems, or fruits or the like of plants P that are sprayed with the plasma functional liquid L are sterilized or disinfected by the active species that are contained in the plasma functional liquid L.

By using an atmospheric pressure plasma device as the plasma head 20, it is possible to configure the Plasma functional liquid producing device 10 to be lightweight and safe, and the Plasma functional liquid producing device 10 can be made compact enough to be carried around. Accordingly, the user can carry the Plasma functional liquid producing device 10 to the vicinity of the cultivating container 3 and spray the plasma functional liquid L towards any plant P. Note that the Plasma functional liquid producing device 10 is not limited to one that sprays the plasma functional liquid L on plants P but could be one that drops the plasma functional liquid L onto plants P.

### <Third Variation>

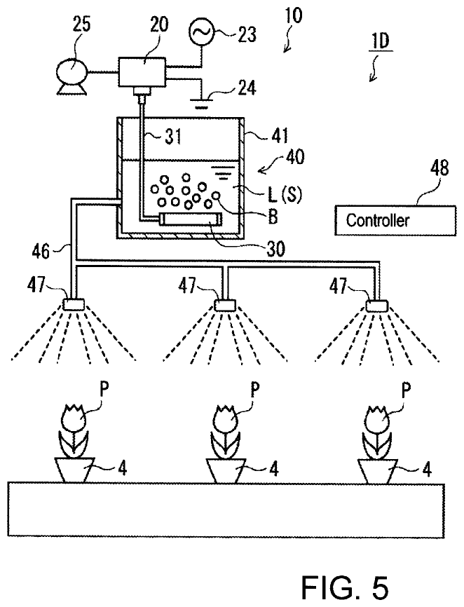

Next, another variation of the plant factory 1A according to the second embodiment will be described based on the drawing. FIG. 5 is a schematic view showing a configuration of a plant factory 1D according to the present variation. Note that the plant factory 1D according to the present variation differs from the plant factory 1A according to the above-described second embodiment in the following points while other configurations are identical. Therefore, identical configurations will be marked with identical reference marks and repetitive descriptions will be omitted.

The plant factory 1D comprises three cultivating containers 4 for cultivating plants P planted into culture soil or the like and a Plasma functional liquid producing device 10.

A Plasma functional liquid generating section 40 comprises a liquid supplying pipe 46 and three spraying heads 47 as the releasing section.

A base end of the liquid supplying pipe 46 is connected to the plasma functional liquid generating tank 41, branches into three on its way, and tip ends thereof are connected to each of the spraying heads 47. The plasma functional liquid L sent by the liquid supplying pipe 46 is pressure fed by means of a pump or the like (not shown).

The spraying heads 47 are positioned above each of the cultivating containers 4 and spray the plasma functional liquid L towards each of the cultivating containers 4. Flowers, leaves, stems, or fruits or the like of plants P onto which the plasma functional liquid L is sprayed are sterilized or disinfected by the active species that are contained in the plasma functional liquid L. Note that the number of the spraying heads 47 can be increased or decreased, depending on the number of plants P or the cultivating containers 4 and the extent the spraying heads 47 spray the plasma functional liquid L.

Operations of the spraying heads 47 are controlled by a controller 48. The controller 48 controls timings and amounts of the plasma functional liquid L sprayed by the spraying heads 47 depending on temperatures obtained by a sensor or the like (not shown) and growing conditions of plants P. Note that the Plasma functional liquid producing device 10 is not limited to one that sprays the plasma functional liquid L on plants P but could be one that drops the plasma functional liquid L onto plants P.

### <Fourth Variation>

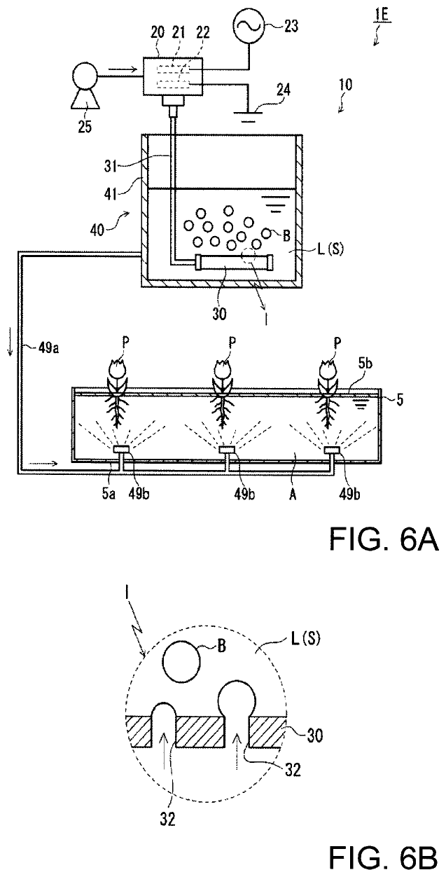

Next, another variation of the plant factory 1A according to the second embodiment will be described based on the drawing. FIGS. 6A-B is a schematic view showing a configuration of a plant factory 1E according to the present variation. Note that the plant factory 1E according to the present variation differs from the plant factory 1A according to the above-described second embodiment in the following points while other configurations are identical. Therefore, identical configurations will be marked with identical reference marks and repetitive descriptions will be omitted.

The plant factory 1E comprises a cultivating tank 5 for spray hydroponic cultivating plants P and a Plasma functional liquid producing device 10.

The cultivating tank 5 comprises a container 5a and a supporting section 5b that supports the plants P and forms a space in the container 5 for underground parts of the plants P to grow.

The Plasma functional liquid producing device 10 comprises a Plasma functional liquid generating section 40 that generates a plasma functional liquid L. The Plasma functional liquid generating section 40 comprises a liquid supplying channel 49a as a liquid supplying section and spraying heads 49b as liquid spraying sections.

The liquid supplying channel 49a sends the plasma functional liquid L to the container 5a. An upstream end of the liquid supplying channel 49a is connected to the plasma functional liquid generating tank 41, branches into three on its way, and tip ends thereof are connected to each of the three spraying heads 49b. The plasma functional liquid L sent by the liquid supplying channel 49a is pressure fed to the spraying heads 49b by means of a pump or the like (not shown).

The three spraying heads 49b are positioned on a bottom section of the container 5a and spray the plasma functional liquid L to each underground part of the plants P. The number of the spraying heads 49a can be increased or decreased depending on the number of plants P or the extent the spraying heads 49a spray the plasma functional liquid L. The roots or the like of the plants P sprayed with the plasma functional liquid L are sterilized or disinfected by the active species that are contained in the plasma functional liquid L.

It is preferable that the average particle size of the plasma functional liquid L that is sprayed from the spraying heads 49b is 30 mm or less. This allows the plasma functional liquid L sprayed from the spraying heads 49b to drift in the container 5a for a predetermined time while the active species that have not reached the underground parts of the plants P will also drift in the atmosphere of the plasma functional liquid L and can be easily absorbed in the underground parts of the plants P so that it is possible to effectively use the active species.

Operations of the spraying heads 49b are controlled by a controller (not shown). The controller controls timings and amounts of the plasma functional liquid L sprayed by the spraying heads 49b depending on temperatures obtained by a sensor or the like (not shown) and growing conditions of plants P. Note that when spraying of the plasma functional liquid L from the spraying heads 49b is stopped, the underground parts of the plant Ps are exposed to air so that the plants P can absorb sufficient oxygen.

In this way, by means of a configuration that comprises the cultivating tank 5 in which the supporting section 5b supports plants P in a state underground parts of the plants P are exposed in the container 5a for hydroponically growing the plants P, spraying heads 49b that spray liquid to the underground parts of the plants P, and the liquid supplying channel 49a that supplies liquid to the spraying heads 49b, wherein the liquid is a plasma functional liquid L that contains active species, the plasma functional liquid L that holds active species with cleaning and sterilizing effects are directly supplied to the underground parts of the plants P so that active species that are contained in the plasma functional liquid L are absorbed by the plants P in a short time and the plants P can be effectively grown at low costs.

### Third Embodiment

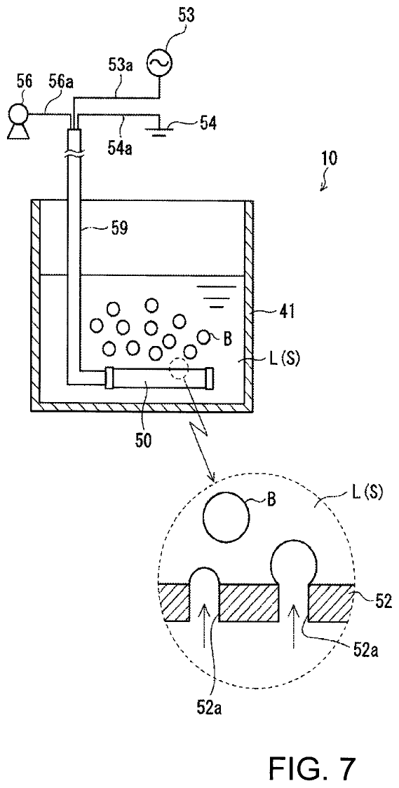

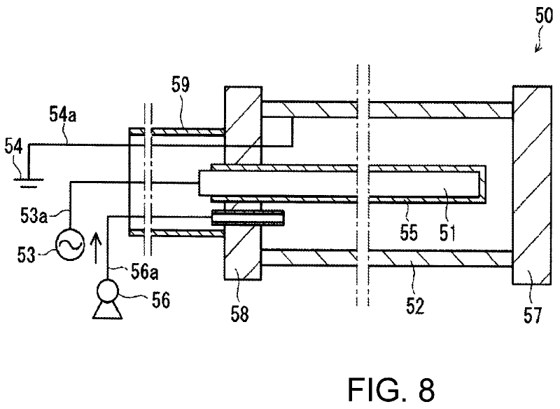

Next, a Plasma functional liquid producing device 10 according to a third embodiment of the present invention will be described based on FIG. 7 and FIG. 8. Note that the Plasma functional liquid producing device 10 differs from the above-described Plasma functional liquid producing device 10 of the first embodiment in the following points while other configurations are identical. Therefore, identical configurations will be marked with identical reference marks and repetitive descriptions will be omitted.

The Plasma functional liquid producing device 10 comprises a plasma head 50, which is a plasma gas generating section in which the plasma gas generating section and the plasma releasing section according to the above-described first embodiment are integrated. The plasma head 50 comprises a cylindrical first electrode 51 and a second electrode 52 that is formed in a hollow, substantially cylindrical shape and that accommodates the first electrode 51 therein. The first electrode 51 and the second electrode 52 are arranged in a substantially coaxial manner. The first electrode 51 and the second electrode 52 are immersed in the plasma functional liquid generating tank 41.

The first electrode 51 is connected to a power source 53 arranged outside the plasma functional liquid generating tank 41 via a power feeding cable 53a and is applied with high frequency voltage by the power source 53. The second electrode 52 is connected to a ground 54 arranged outside the plasma functional liquid generating tank 41 via a grounding wire 54a.

A dielectric layer 55 made of a dielectric coating is provided on an outer periphery of the first electrode 51. Since the dielectric layer 55 is interposed between the first electrode 51 and the second electrode 52, it is possible to stably generate plasma.

Plasma generating gas is sent to the space between the first electrode 51 and the second electrode 52 from a compressor 56 arranged outside the plasma functional liquid generating tank 41 via a gas supplying channel 56a. A downstream end of the gas supplying channel 56a extends into the plasma head 50.

Disc-shaped supporting members 57, 58 are arranged at both ends of the second electrode 52. The supporting member 57 is provided on a tip end side of the second electrode 52. The supporting member 58 is provided on a base end side of the second electrode 52 and supports the first electrode 51, the dielectric layer 55, and the gas supplying channel 56a. Note that reference number 59 in FIG. 7 and FIG. 8 is a protective pipe that protects the power feeding cable 53a, the grounding wire 54a, or the like.

The second electrode 52 is a porous member that exhibits conductivity formed with a number of pores 52a on an outer peripheral surface thereof, and concurrently serves as a plasma gas releasing section. The second electrode 52 introduces bubbles B of the plasma gas into the solvent S in the plasma functional liquid tank 41 by making plasma gas supplied inside through the pores 52a.

Further, it is possible to simplify and downsize the device and to configure it to be portable by connecting the second electrode 52 that exhibits conductivity to the ground 54. Since the second electrode 52 made of metal has a high thermal conductivity and heat generated by the plasma can be effectively dissipated into the solvent S, it is possible to restrict effects of heat to the active species. Moreover, since plasma is generated throughout the second electrode 52, it is possible to generate plasma gas impartially and nearly uniformly in the plasma head 50 and to easily diffuse bubbles B into the solvent S.

In this way, the Plasma functional liquid producing device 10 according to the present embodiment has been configured to comprise the plasma head 50 having the first electrode 51 that is applied with high frequency voltage, the second electrode 52 made of metal that is arranged to face the first electrode 51 with a space between them and that is connected to the ground 54, and the gas supplying channel 56a that supplies plasma generating gas into the space, and the plasma function liquid generating section 40 equipped with the plasma functional liquid generating tank 41 that stores a solvent S to immerse the first electrode 51 and the second electrode 52, wherein plasma gas containing active species, which is generated by generating plasma in plasma generating gas in the space by applying high frequency voltage between the first electrode 51 and the second electrode 52, is introduced into the solvent S in a bubbled state upon passing through the second electrode 52 in order to generate a plasma functional liquid L.

With this configuration, by applying high frequency voltage between the first electrode 51 and the second electrode 52 to generate plasma gas that hold active species from the plasma generating gas, and by introducing this plasma gas into the solvent S in the plasma functional liquid generating tank 41 in a bubbled state upon passing through pores 52a of the second electrode 52 without accompanying excessive heat generation or pressure fluctuations, it is possible to obtain a plasma functional liquid L with excellent cleaning and sterilizing effects that contains long-life active species. Moreover, heat generated during generation of plasma can be effectively dissipated from the second electrode 52 into the solvent S so as to restrict effects of heat to the active species since plasma gas is generated in a state the first electrode 51 and the second electrode 52 are immersed in the plasma functional liquid generating tank 41.

Further, the Plasma functional liquid producing device 10 according to the present embodiment has been configured that a surface of the first electrode 51 is coated with the dielectric layer 55 made of dielectric material.

With this configuration, it is possible to stably generate plasma since the dielectric layer 55 is interposed between the first electrode 51 and the second electrode.

### Fourth Embodiment

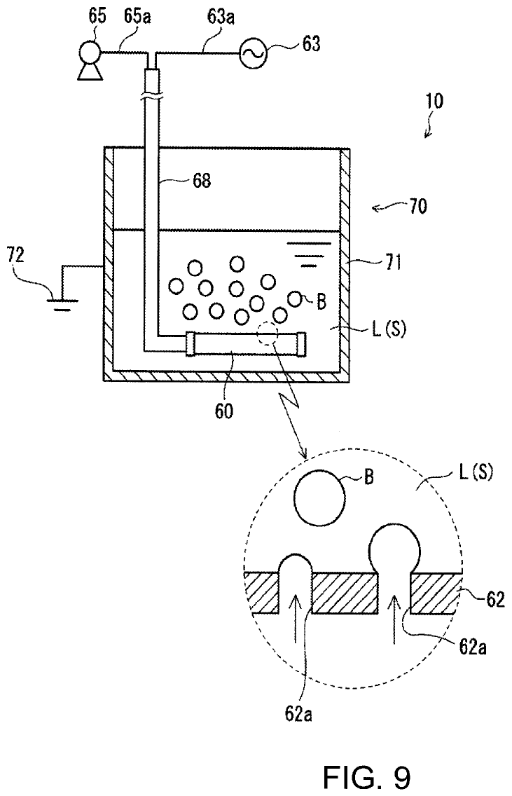

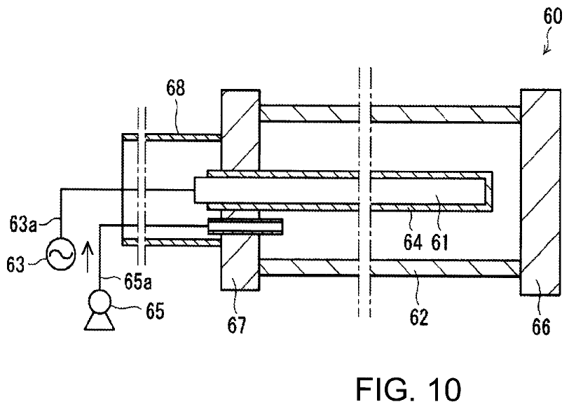

Next, a Plasma functional liquid producing device 10 according to a fourth embodiment of the present invention will be described based on FIG. 9 and FIG. 10. Note that the Plasma functional liquid producing device 10 according to the present embodiment differs from the above-described Plasma functional liquid producing device 10 according to the third embodiment in the following points while other configurations are identical. Therefore, identical configurations will be marked with identical reference marks and repetitive descriptions will be omitted.

The Plasma functional liquid producing device 10 comprises a plasma head 60 in which the plasma gas generating section and the plasma releasing section according to the above-described third embodiment are integrated, and a Plasma functional liquid generating section 70.

The plasma head 60 comprises a cylindrical first electrode 61 and a porous member 62 that is formed in a hollow, substantially cylindrical shape and that accommodates the first electrode 61 therein. The first electrode 61 and the porous member 62 are arranged in a substantially coaxial manner. The first electrode 61 and the porous member 62 are immersed in a plasma functional liquid generating tank 71 to be described later.

The first electrode 61 is connected to a power source 63 arranged outside the plasma functional liquid generating tank 71 via a power feeding cable 63a. A dielectric layer 64 made of a dielectric coating is provided on an outer periphery of the first electrode 61 to enable stable generation of plasma.

Plasma generating gas is sent to a space between the first electrode 61 and the porous member 62 from a compressor 65 via a gas supplying channel 65a. A downstream end of the gas supplying channel 65a extends into the plasma head 60.

The porous member 62 is, for instance, made of ceramic or plastic that exhibits non-conductive properties. The porous member 62 is formed with a number of pores 62a on an outer peripheral surface thereof. Disc-shaped supporting members 66, 67 are arranged at both ends of the porous member 62.

The supporting member 66 is provided on a tip end side of the porous member 62. The supporting member 67 is provided on a base end side of the porous member 62 and supports the first electrode 61, the dielectric layer 64, and the gas supplying channel 65a. Note that reference number 68 in FIG. 9 and FIG. 10 is a protective pipe that protects the power feeding cable 63a, the gas supplying channel 65a, or the like.

The Plasma functional liquid generating section 70 comprises the plasma functional liquid generating tank 71 that stores a solvent S that exhibits conductivity and immerses the plasma head 60 in the solvent S. The plasma functional liquid generating tank 71 is connected to a ground 72. Thus, the solvent S functions as a second electrode that pairs with the first electrode 61. Using the solvent S as the second electrode omits the necessity of separately preparing a member that comprises the second electrode, and it is possible to simplify and downsize the device and to configure it to be portable. Note that it is possible to provide an electrode in the plasma functional liquid generating tank 71 instead of using the ground 72.

When high frequency voltage is applied between the first electrode 61 and the solvent S, plasma is generated throughout the first electrode 61, and plasma gas is generated impartially and nearly uniformly in the plasma head 60. As the plasma gas passes through the pores 62a of the porous material 62, bubbles B of the plasma gas are introduced into the solvent S in the plasma functional liquid generating tank 71 to generate a plasma functional liquid L.

In this way, the Plasma functional liquid producing device 10 according to the present embodiment has been configured to comprise the plasma head 60 having the first electrode 61 that is applied with high frequency voltage, the non-conductive porous member 62 that is arranged to face the first electrode 61 with a space between them, and the gas supplying channel 65a that supplies plasma generating gas into the space, and the plasma function liquid generating section 70 equipped with the plasma functional liquid generating tank 71 that stores a solvent S to immerse the first electrode 61 and the porous member 62 and that is connected to the ground 72, wherein plasma gas containing active species generated by generating plasma in plasma generating gas in the space by applying high frequency voltage between the first electrode 61 and the solvent S, which is the second electrode that pairs with the first electrode 61, is introduced into the solvent S in a bubbled state upon passing through the porous member 62 in order to generate a plasma functional liquid L.

With this configuration, by applying high frequency voltage between the first electrode 61 and the solvent S to generate plasma gas that holds active species from the plasma generating gas, and by introducing this plasma gas into the solvent S in the plasma functional liquid generating tank 71 in a bubbled state upon passing through pores 62a of the porous member 62 without accompanying excessive heat generation or pressure fluctuations, it is possible to obtain a plasma functional liquid L with excellent cleaning and sterilizing effects that contains long-life active species. Moreover, heat generated during generation of plasma can be effectively dissipated from the porous material 62 into the solvent S so as to restrict effects of heat to the active species since plasma gas is generated in a state the first electrode 61 and the porous material 62 are immersed in the plasma functional liquid generating tank 71.

### Examples

### First Experimental Example

Comparative experiments were conducted on disinfecting effects of respective plasma gases generated when oxygen, carbon dioxide, air and nitrogen were used as plasma generating gases.

First, 250 ml of spore suspension was prepared by mixing 248 ml of purified water and 2 ml of spore fluid. Fusarium oxysporum f.sp. fragariae: NBRC 31982 was used as spores in the spore fluid. These are spores primarily causing strawberry chlorosis, and it is possible to control diseases of strawberries to restrict growth inhibition and dying by sterilization and disinfection.

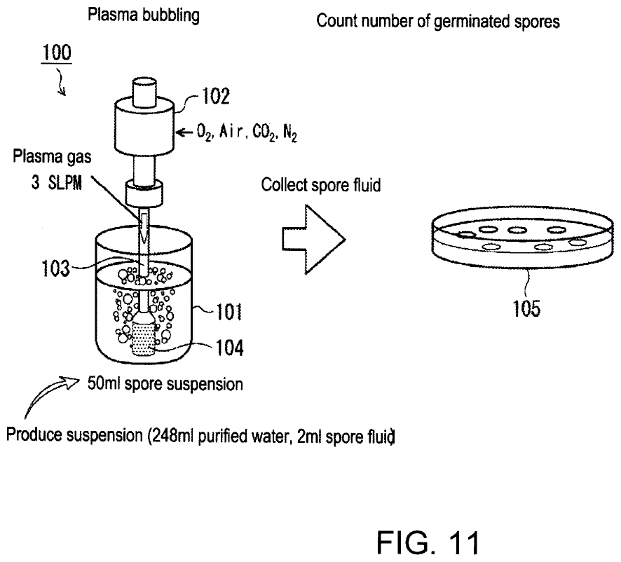

Next, as shown in FIG. 11, 50 ml of the spore suspension was placed in a beaker 101 and plasma treated with plasma gas in a plasma bubbling device 100. The plasma gas generated by a multi-gas plasma jet 102, which is the plasma generating section, was sent to a porous filter 104, which is the plasma releasing section, immersed in the spore suspension upon passing through a tubular piping 103 and introduced to the spore suspension in a bubbled state. The length of the tubular piping 103 was set to approximately 90 mm, the length of the porous filter 104 to approximately 20 mm, and the flow rate of the introduced plasma gas was set to 3 SLPM, respectively.

Four types, that is, oxygen, carbon dioxide, air and nitrogen, were prepared as plasma generating gas used to generate plasma gas, and the time (processing time) for introducing the plasma gas generated from each of them into the spore suspension in a bubbled state was set to 0 seconds, 120 seconds, 300 seconds, and 600 seconds, respectively.

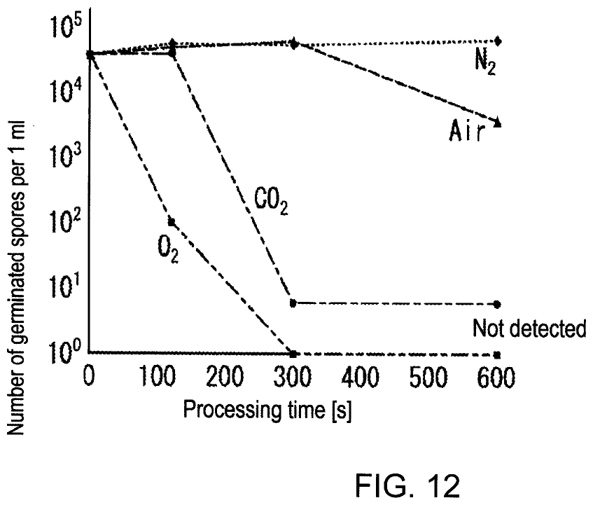

Then, 1 ml of the spore suspension that is introduced with the plasma gas in a bubbled state was dropped onto an agar medium in a Schale 105 after step dilution, and after two days of incubation at room temperature, the number of germinated spores was counted. The results are shown in FIG. 12.

It can be understood from FIG. 12 that excellent disinfecting effects can be achieved by introducing plasma gas through bubbling for 120 seconds when the plasma gas uses oxygen gas as the plasma generating gas, for 300 seconds or more when the plasma gas uses carbon dioxide gas as the plasma generating gas, and for 600 seconds or more when the plasma gas uses air as the plasma generating gas. On the other hand, it can be understood that the disinfecting effect of plasma gas using nitrogen gas as the plasma generating gas is smaller than those of plasma gases generated from oxygen, carbon dioxide, or air. These results indicate that it is most effective to use oxygen gas as the plasma generating gas.

### Second Experimental Example

Next, experiments were conducted to verify the relationship between the oxygen concentration of oxygen gas that is contained in the plasma generating gas and the disinfecting effects of plasma gas.

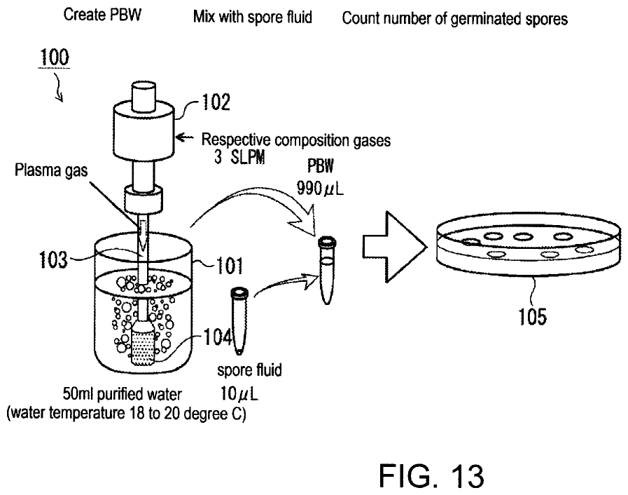

As shown in FIG. 13, 50 ml of purified water was placed in a beaker 101, and plasma gas was introduced into the purified water using the plasma bubbling device 100. Specifically, plasma gas generated by the multi-gas plasma jet 102, which is the plasma generating section, was sent to the porous filter 104, which is the plasma releasing section, immersed in purified water upon passing through the tubular piping 103 and introduced to the purified water in a bubbled state via the porous filter 104. The length of the tubular piping 103 was set to approximately 90 mm, the length of the porous filter 104 to approximately 20 mm, and the flow rate of the introduced plasma gas was set to 3 SLPM, respectively.

The following five types were prepared as plasma generating gases, and the time (processing time) for introducing the plasma gas generated from each of them into purified water in a bubbled state was set to 60 seconds and 300 seconds, respectively.
Plasma generating gas 1: 100% air (21% oxygen, 78% nitrogen, 1% argon)
Plasma generating gas 2: 40% oxygen, 58% nitrogen, 2% argon
Plasma generating gas 3: 70% oxygen, 27% nitrogen, 3% argon
Plasma generating gas 4: 90% oxygen, 6% nitrogen, 4% argon
Plasma generating gas 5: 100% oxygen

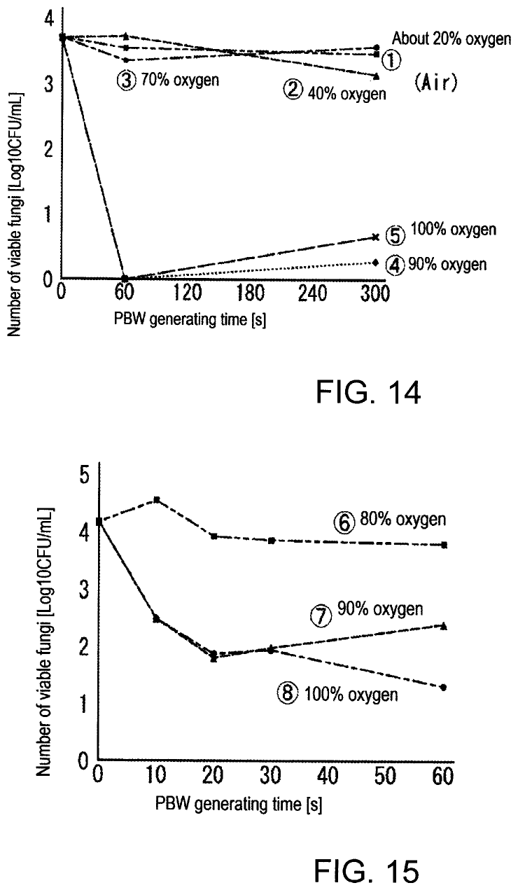

Then, 10 ml of spore fluid was mixed into 990 ml of purified water introduced with plasma gas in a bubbled state and allowed to stand for 10 minutes to produce a spore suspension. Fusarium oxysporum f.sp. fragariae: NBRC 31982 was used as spores in the spore fluid. Then, 1 ml of the spore suspension was dropped onto an agar medium in a Schale 105 after step dilution, and after two days of incubation at room temperature, the number of germinated spores was counted. The results are shown in FIG. 14.

According to FIG. 14, when the oxygen concentration of the plasma generating gas was set to 90% and 100%, the number of viable fungi significantly reduced and remarkable disinfecting effects could be observed when the bubbling time (processing time) was 60 seconds and 300 seconds. On the other hand, when the oxygen concentration of the plasma generating gas was set to 21% oxygen, 40% oxygen, and 70% oxygen, the reduction in the number of viable fungi, that is, the disinfecting effect, is smaller compared to cases the oxygen concentration was 90% and 100%.

### Third Experimental Example

Next, experiments were conducted to further verify the relationship between the oxygen concentration of oxygen gas that is contained in the plasma generating gas and the disinfecting effects of plasma gas.

Similarly to the Second Experimental Example, 990 ml of purified water introduced with plasma gas in a bubbled state was mixed to 10 ml of spore fluid to produce a spore suspension. Similarly to the Second Experimental Example, Fusarium oxysporum f.sp. fragariae: NBRC 31982 was used as spores in the spore fluid.

The following three types were prepared as plasma generating gases, and the time (processing time) for introducing the plasma gas generated from each of them into purified water in a bubbled state was set to 10 seconds, 20 seconds, 30 seconds, and 60 seconds, respectively. Then, similarly to the Second Experimental Example, 1 ml of the spore suspension was dropped onto an agar medium in a Schale 105 after step dilution, and after two days of incubation at room temperature, the number of germinated spores was counted. The results are shown in FIG. 15.
Plasma generating gas 6: 80% oxygen, 17% nitrogen, 3% argon
Plasma generating gas 7: 90% oxygen, 6% nitrogen, 4% argon
Plasma generating gas 8: 100% oxygen

It is apparent from FIG. 15 that when the oxygen concentration of the plasma generating gas was set to 90% and 100%, the number of viable fungi significantly reduced and remarkable disinfecting effects could be obtained when the bubbling time (processing time) was 10 seconds or more. On the other hand, when the oxygen concentration of the plasma generating gas was set to 80%, the reduction in the number of viable fungi, that is, the disinfecting effect, is smaller compared to cases the oxygen concentration was 90% and 100%.

Note that while experiments were conducted with the same components for the plasma generating gas 4 of the Second Experimental Example and the plasma generating gas 7 of the Third Experimental Example, the numbers of spores per unit volume of the spore fluid used in the experiments were different for each experiment, and the numbers of viable fungi before the incubation in the Schale were different so that absolute values of the viable fungi are different in FIG. 14 and FIG. 15. The same applies for the plasma generating gas 5 of the Second Experimental Example and the plasma generating gas 8 of the Third Experimental Example.

### Fourth Experimental Example

Next, experiments were conducted to further verify the relationship between the oxygen concentration of the oxygen gas that is contained in the plasma generating gas and the disinfecting effects of plasma gas when the processing time was set to 60 seconds.

Similarly to the Third Experimental Example, 990 ml of purified water introduced with plasma gas in a bubbled state was mixed to 10 ml of spore fluid to produce a spore suspension. Similarly to the Third Experimental Example, Fusarium oxysporum f.sp. fragariae: NBRC 31982 was used as spores in the spore fluid.

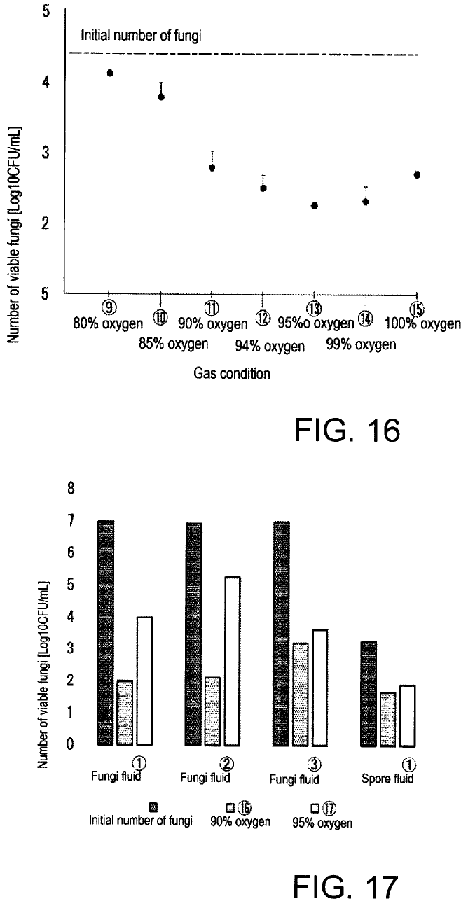

The following seven types were prepared as plasma generating gases, and plasma gases in a bubbled state generated from each of them were introduced into purified water for 60 seconds. Then, similarly to the Second Experimental Example, 1 ml of the spore suspension was dropped onto an agar medium in a Schale 105 after step dilution, and after two days of incubation at room temperature, the number of germinated spores was counted. The results are shown in FIG. 16. In FIG. 16, the horizontal axis indicates the following plasma generating gases 9 to 15 while the vertical axis indicates the number of viable fungi. Note that the dashed line in FIG. 16 indicates the number of fungi at the start of the experiment (initial number of fungi).
Plasma generating gas 9: 80% oxygen, 17% nitrogen, 3% argon
Plasma generating gas 10: 85% oxygen, 11% nitrogen, 4% argon
Plasma generating gas 11: 90% oxygen, 6% nitrogen, 4% argon
Plasma generating gas 12: 94% oxygen, 1% nitrogen, 5% argon
Plasma generating gas 13: 95% oxygen, 0% nitrogen, 5% argon
Plasma generating gas 14: 99% oxygen, 1% nitrogen, 0% argon
Plasma generating gas 15: 100% oxygen, 0% nitrogen, 0% argon

It is apparent from FIG. 16 that when the plasma generating gases 9 to 10 are used, the number of reduced fungi, which is the difference between the initial number of fungi and the number of viable fungi, is 1 or less in logarithmic representation, that is, less than 1/10 in linear representation. On the other hand, when the plasma generating gases 11 to 15 are used, the number of reduced fungi is 1 or more in logarithmic representation, that is, 1/10 or more in linear representation in all of the cases.

### Fifth Experimental Example

While Fusarium oxysporum f.sp. fragariae: NBRC 31982 was used as spores in the spore solution in Examples 1 to 4, disinfecting effects on fungi or the like other than Fusarium oxysporum f.sp. fragariae: NBRC 31982 were verified in this example. In this example, the following three types of fungi fluids that contains fungi and one type of spore fluid were used, and similarly to the Third Experimental Example, 990 ml of purified water introduced with plasma gas in a bubbled state was mixed to 10 ml of the fungi fluid or the spore fluid to produce a fungi suspension or a spore suspension.
Fungi fluid 1: S. aureus (Staphylococcus aureus)
Fungi fluid 2: E. coli (Escherichia coli)
Fungi fluid 3: P. aeruginosa (Pseudomonas aeruginosa)
Spore fluid 1: Gray mold fungus

The following two types of plasma generating gases of different oxygen concentrations generated with a PSA-type oxygen concentrator were prepared. Note that the nitrogen and argon concentrations in the plasma generating gases 16 to 17 are estimated values.
Plasma generating gas 16: 90% oxygen, 5.7% nitrogen, 4.3% argon
Plasma generating gas 17: 95% oxygen, 0.5% nitrogen, 4.5% argon.

Then, plasma gases generated from the plasma generating gases were introduced in a bubbled state into purified water for 60 seconds. Then, similarly to the Second Experimental Example, 1 ml of the spore suspension was dropped onto an agar medium in a Schale 105 after step dilution, and after two days of incubation at room temperature, the number of germinated spores was counted. The results are shown in FIG. 17. In FIG. 17, the horizontal axis indicates the above-described fungi fluids 1 to 3 while the vertical axis indicates the number of viable fungi when the plasma generating gases 16 to 17 are used in the above-described fungi fluids 1 to 3 and the spore fluid 1.

It is apparent from FIG. 17 that the number of reduced fungi, which is the difference between the initial number of fungi and the number of viable fungi, is 1 or more in logarithmic representation, that is, 1/10 or more in linear representation for all of the fungi fluids 1 to 3 and the spore fluid 1 by using plasma generating gases with oxygen concentrations of 90% and 95%.

In this way, it is apparent from the First Example that oxygen gas is highly effective as a plasma generating gas, and it is apparent from the Second to Fourth Examples that remarkable disinfecting effects can be achieved particularly when the oxygen concentration is at least 90% or more. Further, it is apparent from the Fifth Example that the use of oxygen gas as the plasma generating gas exhibits effective disinfecting effects not only on Fusarium oxysporum f.sp. fragariae: NBRC 31982, which are spores that primarily cause strawberry chlorosis, but also on S. aureus (Staphylococcus aureus), E. coli (E. coli), and P. aeruginosa (P. aeruginosa), or gray mold.

However, setting the oxygen concentration to be higher than 95% would require an extremely expensive high concentration oxygen generator, which is not practical, while it is possible to use a compact oxygen concentrator by setting the oxygen concentration to be 95% or less. Further, an excessively high oxygen concentration increases the amount of generated ozone, which leads to concerns about effects on the human body or plants or the like. Particularly when the oxygen concentration becomes higher than 95%, ozone introduced into fluid will not dissolve in the liquid but be released into air so that separate measures against ozone are required. Accordingly, considering workability and costs, a favorable oxygen concentration is 90% or more and 95% or less.

When the oxygen concentration is 95% or more, the plasma generating gas also contains nitrogen gas. Therefore, nitrate ion, which functions as a nutrient for the growth of plants, is generated in the active species in the plasma functional liquid L.

The present invention is not limited to the above embodiments and variations and can be modified in various ways other than those described above as long as the spirit of the invention is not departed from, and it is obvious that the present invention extends to such modifications. Moreover, each embodiment and each variation may be combined.

### LIST OF REFERENCE SIGNS

1A, 1B, 1C, 1D, 1E: Plant factory
2, 5: Cultivating tank
2a, 5a: Container
2b, 5b: Supporting section
3, 4: Cultivating container
10: Plasma functional liquid producing device
20: Plasma head
21: First electrode
22: Second electrode
23: Power source
24: Grounding
25: Compressor
30: Plasma gas releasing section
31: Gas conveying channel
32: Pore
40: Plasma functional liquid generating section
41: Plasma functional liquid generating tank
42: Liquid supplying channel
43: Liquid refluxing channel
44, 46: Liquid supplying pipe
45, 47: Spraying head
48: Controller
49a: Liquid supplying channel
49b: Spraying head
50: Plasma head
51: First electrode
52: Porous member (second electrode)
52a: Pore
53: Power source
53a: Power feeding cable
54: Grounding
54a: Grounding wire
55: Dielectric layer
56: Compressor
56a: Gas supplying channel
57, 58: Supporting member
60: Plasma head
61: First electrode
62: Porous member
62a: Pore
63: Power source
63a: Power feeding cable
64: Dielectric layer
65: Compressor
65a: Gas supplying channel
66, 67: Supporting member
70: Plasma functional liquid generating section
71: Plasma functional liquid generating tank (second electrode)
72: Grounding
A: Solution
B: Bubbles
L: Plasma functional liquid
P: Plant
S: Solvent

What is claimed is:

1. A Plasma functional liquid producing device, comprising:
a plasma gas generating section that generates plasma gas containing active species from plasma generating gas,
a plasma gas releasing section that releases the plasma gas in a bubbled state, and
a Plasma functional liquid generating section equipped with a plasma functional liquid generating tank storing a solvent, which generates a plasma functional liquid by introducing the plasma gas in the bubbled state into the solvent,
wherein an oxygen concentration of the plasma generating gas is 90% or more, and
wherein the Plasma functional liquid generating section comprises a releasing section capable of releasing the plasma functional liquid to a cultivating container for cultivating plants or a cultivating tank for hydroponically growing plants arranged outside the plasma functional liquid generating tank.

2. The Plasma functional liquid producing device as recited in claim 1, wherein:
the oxygen concentration of the plasma generating gas is 90% or more and 95% or less.

3. The Plasma functional liquid producing device as recited in claim 1, wherein:
the nitrogen concentration of the plasma generating gas is 0.5% or more.

4. The Plasma functional liquid producing device as recited in claim 1, wherein:
the plasma generating section is arranged outside the plasma functional liquid generating tank, and
the plasma gas releasing section is a porous member that is immersed in the solvent stored in the plasma functional liquid generating tank and that releases the plasma gas in a bubbled state.

5. The Plasma functional liquid producing device as recited in claim 4, wherein:
the porous member is made of copper, silver, or an alloy thereof.

6. The Plasma functional liquid producing device as recited in claim 1, wherein:
the plasma gas generating section and the plasma gas releasing section are configured integrally and immersed into a solvent stored in the plasma functional liquid generating tank,
wherein the plasma gas releasing section is a porous member made of metal that releases the plasma gas in a bubbled state,
wherein the plasma gas generating section supplies the plasma generating gas to a space between a first electrode that is applied with high frequency voltage and the porous member, which is a second electrode that is arranged to oppose the first electrode and that is connected to a grounding, and generates the plasma gas that contains active species by applying high frequencies between the first electrode and the second electrode, and
wherein the plasma gas is intruded into the solvent in a bubbled state upon passing through the second electrode to generate the plasma functional liquid.

7. The Plasma functional liquid producing device as recited in claim 1, wherein:
the plasma gas generating section and the plasma gas releasing section are configured integrally and immersed into a solvent that exhibits conductivity stored in the plasma functional liquid generating tank,
wherein the plasma gas releasing section is a non-conductive porous member that releases the plasma gas in a bubbled state,
wherein the plasma gas generating section supplies the plasma generating gas to a space between a first electrode that is applied with high frequency voltage and the porous member that is arranged to oppose the first electrode, and generates the plasma gas that contains active species by applying high frequencies between the first electrode and the solvent, which is a second electrode, and
wherein the plasma gas is introduced into the solvent in a bubbled state upon passing through the porous member to generate the plasma functional liquid.

8. The Plasma functional liquid producing device as recited in claim 6, wherein:
a dielectric layer made of a dielectric coating is coated on a surface of the first electrode.

9. The Plasma functional liquid producing device as recited in claim 1, wherein:
bubbles of the plasma gas are microbubbles or ultrafine bubbles.

10. A plant factory comprising:
the Plasma functional liquid producing device as recited in claim 1, and
the cultivating container,
wherein the releasing section drops or sprays the plasma functional liquid on the plants.

11. A plant factory comprising:
the Plasma functional liquid producing device as recited in claim 1, and
the cultivating tank,
wherein the releasing section supplies the plasma functional liquid to the cultivating tank.

12. The plant factory as claimed in claim 11, wherein:
the solvent is a liquid fertilizer,
wherein the plasma generating gas contains at least nitrogen, and
wherein the Plasma functional liquid generating section comprises a refluxing channel that refluxes the plasma functional liquid that is supplied to the cultivating tank from the cultivating tank to the plasma functional liquid generating tank.

13. A plant factory comprising:
the Plasma functional liquid producing device as recited in claim 1, and
the cultivating tank in which a supporting section supports plants in a state underground parts of the plants are exposed in a container to hydroponically grow the plants,
wherein the releasing section comprises a liquid spraying section that sprays the plasma functional liquid to the underground parts and a liquid supplying section that supplies the plasma functional liquid to the liquid spraying section.

14. A plasma functional liquid generating method that uses a Plasma functional liquid producing device comprising:
a plasma gas generating section that generates plasma gas containing active species from plasma generating gas,
a plasma gas releasing section that releases the plasma gas in a bubbled state, and
a Plasma functional liquid generating section equipped with a plasma functional liquid generating tank storing a solvent, which generates a plasma functional liquid by introducing the plasma gas in the bubbled state into the solvent,
wherein an oxygen concentration of the plasma generating gas is 90% or more, and
wherein the Plasma functional liquid generating section comprises a releasing section capable of releasing the plasma functional liquid to a cultivating container for cultivating plants or a cultivating tank for hydroponically growing plants arranged outside the plasma functional liquid generating tank.

15. The plasma functional liquid generating method as recited in claim 14, wherein:
the oxygen concentration of the plasma generating gas is 90% or more and 95% or less.

16. The plasma functional liquid generating method as recited in claim 14, wherein:
that a nitrogen concentration of the plasma generating gas is 0.5% or more.

17. The plasma functional liquid generating method as recited in claim 14, wherein:
the plasma generating section is arranged outside the plasma functional liquid generating tank, and
a porous member of the plasma gas releasing section is immersed in the solvent stored in the plasma functional liquid generating tank and releases the plasma gas in a bubbled state when the plasma gas passed through.
